(19) United States
(12) Patent Application Publication
(10) Pub. No.: US 2008/0187784 A1
(43) Pub. Date: Aug. 7, 2008

(54) MAGNETIC RECORDING MEDIUM

(75) Inventors: Kuniyuki DOI, Otsu-shi (JP); Tetsuo KAWAKUSU, Otsu-shi (JP); Hiroyuki TANAKA, Chuo-ku (JP); Kazunori TAMAZAKI, Chuo-ku (JP)

Correspondence Address: KENYON & KENYON LLP, 1500 K STREET N.W., SUITE 700, WASHINGTON, DC, 20005, US

(73) Assignees: TOYO BOSEKI KABUSHIKI KAISHA, Osaka (JP); TDK CORPORATION, Tokyo (JP)

(21) Appl. No.: 12/026,119

(22) Filed: Feb. 5, 2008

(30) Foreign Application Priority Data
Feb. 5, 2007 (JP) 2007-025829

(51) Int. Cl. G11B 5/702

(52) U.S. Cl. 428/840.2

(57) ABSTRACT

The invention provides a magnetic recording medium having a structure in which a magnetic layer containing magnetic particles and a binder is formed on a nonmagnetic layer containing nonmagnetic particles and a binder, wherein the binder contained in the nonmagnetic layer contains a polyurethane resin having 50 to 100 eq/t of metal phosphate groups and 800 to 1600 eq/t of unsaturated hydrocarbon groups in its molecule and obtained by reacting a polyester polyol (A) containing an aliphatic dicarboxylic acid as an acid component, an aromatic polyisocyanate compound (B) and a compound (C) having unsaturated hydrocarbon groups and a functional group which reacts with an isocyanate group and a molecular weight of 500 or less, and the nonmagnetic layer has good dispersibility even by using fine nonmagnetic particles and can ensure satisfactory coating film strength even at a radiation dose of 3 Mrad or less.

### FIELD OF THE INVENTION

The present invention relates to a magnetic recording medium.

### DESCRIPTION OF THE BACKGROUND

In recent years, a high density of a magnetic recording medium, such as a magnetic tape, is required along with the spread of large capacity memories. Such a magnetic recording medium usually has a structure in which a magnetic layer containing magnetic particles and a binder is formed on a nonmagnetic layer containing nonmagnetic particles and a binder.

Japanese Patent Laying-Open Nos. 11-213379 (hereinafter, referred to as “Patent Reference 1”) and 2005-149623 (hereinafter, referred to as “Patent Reference 2”) disclose that radiation (electron beam)-curable polyurethane resins are used as a binder for a nonmagnetic layer of a magnetic recording medium. These radiation-curable polyurethane resins are polyurethane acrylate resins having at least one (preferably 2 to 20) unsaturated hydrocarbon group and a phosphorus-containing polar group in a molecule. As disclosed in Patent References 1 and 2, when a nonmagnetic layer containing this radiation-curable polyurethane resin is formed, enough hardness can be obtained by applying an electron beam at a dose of 3 Mrad.

The nonmagnetic layer of the magnetic recording medium is formed, for example, by applying a coating paint containing nonmagnetic particles and the aforementioned radiation-curable polyurethane resin to one surface of a nonmagnetic support (base film) with conveying the support and applying a radiation to cure the radiation-curable polyurethane resin in the coating paint. In these days, it is desired to more improve the productivity of magnetic recording mediums, and therefore it is necessary to raise the running speed of the nonmagnetic support. However, if the running speed of the nonmagnetic support is too high, the dose of the radiation to be applied to the radiation-curable polyurethane resin may be 3 Mrad or less. Therefore, there is a fear that the radiation-curable polyurethane resin disclosed in Patent Reference 1 and 2 is insufficiently cured, with the result that there is a fear of the occurrence of such a problem concerning a deterioration in electromagnetic transformation characteristics of produced magnetic recording mediums.

Further, in recent years, the development of a high-recording-density magnetic recording medium has particularly progressed. For this reason, there is a future trend toward a shorter recording wavelength, a narrower recording track width, a thinner recording medium and a decrease in a minimum recording unit. To cope with this trend, the development of a thinner magnetic layer has progressed, and ferromagnetic metal particles and hexagonal ferrite magnetic particles which are fine particles and have a large magnetic energy have come to be used as the magnetic particles to be used in the magnetic layer.

However, when the magnetic layer is thin-layered, its surface smoothness is strongly affected by the irregular condition of the surface of the nonmagnetic layer disposed thereunder. Therefore, it is required to improve the surface smoothness of the nonmagnetic layer in order to secure better surface smoothness of the magnetic layer. For this, it is considered to use more fine nonmagnetic particles such as iron oxide particles having an average major axis length of 150 nm or less. However, when the aforementioned fine iron oxide particles are applied as the nonmagnetic particles in the case where the radiation-curable polyurethane resin disclosed in Patent Reference 1 is used as the binder of the nonmagnetic layer, the dispersibility of the iron oxide particles tend to be insufficient, resulting in a deterioration in the surface smoothness due to this dispersibility. Furthermore, a deteriorating in the surface smoothness of the magnetic layer on the nonmagnetic layer and therefore there is a fear of deteriorated electromagnetic conversion characteristics.

With the recent demands for the development of a high-recording-density magnetic recording medium as mentioned above, it is desired to attain a magnetic recording medium provided with a magnetic layer which can secure good surface smoothness even if the development of a thinner film magnetic layer and microparticulation of the magnetic particles and nonmagnetic particles are promoted to thereby attain both a high recording density and electromagnetic transformation characteristics such as an S/N ratio (SNR) and medium characteristics such as an error rate.

### SUMMARY OF THE INVENTION

The present invention has been made to solve the above problems and it is an object of the present invention to provide a magnetic recording medium provided with a nonmagnetic layer which has good dispersibility even if fine nonmagnetic particles are used, and can secure sufficient coating strength even if the layer is irradiated with a radiation at a dose of 3 Mrad or less.

The magnetic recording medium of the present invention has a structure in which a magnetic layer containing magnetic particles and a binder is formed on a nonmagnetic layer containing nonmagnetic particles and a binder, wherein the binder contained in the nonmagnetic layer contains a polyurethane resin which has 50 to 100 eq/t of metal phosphate groups and 800 to 1600 eq/t of unsaturated hydrocarbon groups in its molecule and is obtained by reacting a polyester polyol (A) containing an aliphatic dicarboxylic acid as an acid component, an aromatic polyisocyanate compound (B) and a compound (C) having unsaturated hydrocarbon groups and a functional group which reacts with an isocyanate group and a molecular weight of 500 or less.

According to the present invention, the polyurethane resin used as the binder in the nonmagnetic layer can be sufficiently cured by applying a radiation at a low dose and it is therefore possible to attain a magnetic recording medium provided with a nonmagnetic layer having sufficient coating strength. Because such a magnetic recording medium according to the present invention can be manufactured by irradiating radiation at a low dose, its productivity is improved sufficiently. Further, the present invention can attain a magnetic recording medium having a sufficiently low center line average roughness, and a sufficiently low bit error rate.

The nonmagnetic particles contained in the nonmagnetic layer in the present invention preferably contain iron oxide particles having an average major axis length of 150 nm or less.

The binder contained in the nonmagnetic layer in the present invention is preferably a polyurethane resin obtained by further reacting with a compound (D) having a functional group which reacts with an isocyanate group and having a molecular weight of 800 or less.

Also, it is preferable that the polyester polyol (A) in the present invention contains 70 to 100 mol % of an aliphatic dicarboxylic acid in an acid component and the compound (C) has 2 to 4 unsaturated hydrocarbon groups in one molecule.

Moreover, the thickness of the magnetic layer in the present invention is preferably 300 nm or less.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view typically showing a magnetic recording medium (magnetic tape) 1 in an example of the present invention.

### DESCRIPTION OF THE PREFERRED EMBODIMENTS

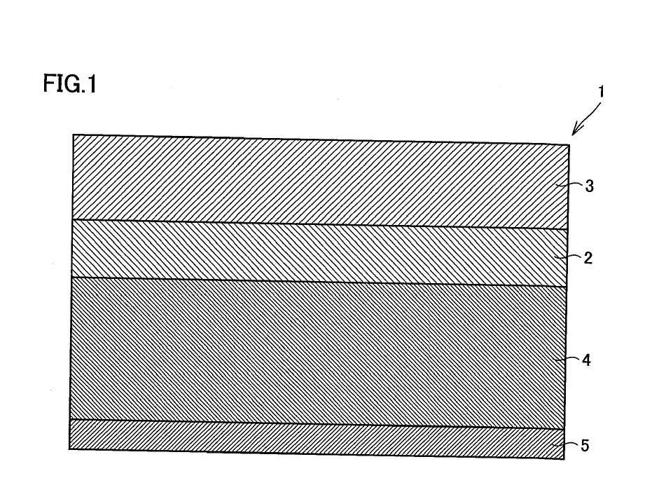

FIG. 1 is a sectional view typically showing an example of a magnetic recording medium (magnetic tape) 1 of the present invention. The magnetic recording medium 1 of the present invention is provided with a structure in which a magnetic layer 3 containing magnetic particles and a binder is formed on a nonmagnetic layer 2 containing nonmagnetic particles and a binder. Further, in the magnetic recording medium 1 of the present invention, as shown by an example in FIG. 1, the nonmagnetic layer 2 and the magnetic layer 3 are formed in this order on one surface of a base film 4 so as to allow various recording data to be recorded and read by a recording and reproducing device (not shown), and also, a backcoat layer 5 is formed on the other surface of the base film 4. It is to be noted that in FIG. 1, the magnetic recording medium 1 is illustrated in such a manner that each layer is magnified to a size having a more higher thickness and also, the ratio of the thickness of each layer is changed to a ratio different from an actual one, to make it easy to understand the present invention. The magnetic recording medium 1 of the present invention is characterized that the binder contained in the nonmagnetic layer 2 contains a certain polyurethane resin (radiation-curable polyurethane resin) which is obtained by reacting a polyester polyol (A), an aromatic polyisocyanate compound (B) and a compound (C) having unsaturated hydrocarbon groups and a functional group which reacts with an isocyanate group and a molecular weight of 500 or less.

The polyester polyol (A) used in the present invention is obtained by polymerization condensation of a usual dibasic acid and glycol and contains an aliphatic dicarboxylic acid as an acid component. Examples of the aliphatic dicarboxylic acid include, but not limited to, succinic acid, adipic acid, azelaic acid, sebacic acid, dodecanedicarboxylic acid, dodecynylsuccinic acid, fumaric acid, maleic acid, itaconic acid and 3-hexenedicarboxylic acid. Among these acids, at least any one selected from adipic acid, sebacic acid, dodecynylsuccinic acid and itaconic acid is preferably contained as the aliphatic dicarboxylic acid from the viewpoint of the dispersibility of the nonmagnetic particles.

The polyester polyol (A) in the present invention may contain other acid components other than the above aliphatic dicarboxylic acids. Examples of the acid components include aromatic dibasic acids such as terephthalic acid, isophthalic acid, orthophthalic acid and naphthalenedicarboxylic acid, alicyclic dibasic acids such as 1,2-cyclohexanedicarboxylic acid, 1,3-cyclohexanedicarboxylic acid, 1,4-cyclohexanedicarboxylic acid, 4-methyl-1,2-cyclohexanedicarboxylic acid, 1,2-bis(4-carboxycyclohexyl)methane and 2,2-bis(4-carboxycyclohexyl)propane, and the like. In this case, if the aromatic dibasic acid is contained in an amount exceeding 30 mol % in the acid component, there is a fear that the resin is only insufficiently cured at a radiation dose less than 3 Mrad. Therefore, when the aromatic dibasic acid is contained, the amount of that dibasic acid is preferably 30 mol % or less in the acid component.

Examples of the glycol component used in the polyester polyol (A) in the present invention include, but not particularly limited to, aliphatic glycols such as ethylene glycol, propylene glycol, 1,3-propanediol, 1,4-butanediol, 1,5-pentanediol, 1,6-hexanediol, 1,2-propylene glycol, 1,3-propylene glycol, 1,3-butylene glycol, 2,3-butylene glycol, 2,2-dimethyl-1,3-propanediol, 3-methyl-1,5-pentanediol, 2,2-dimethyl-3-hydroxypropyl-2′,2′-dimethyl-3-hydroxypropanate and 2,2-diethyl-1,3-propanediol and alicyclic glycols such as 1,3-bis(hydroxymethyl)cyclohexane, 1,4-bis(hydroxymethyl)cyclohexane, 1,4-bis(hydroxyethyl)cyclohexane, 1,4-bis(hydroxypropyl)cyclohexane, 1,4-bis(hydroxymethoxy)cyclohexane, 1,4-bis(hydroxyethoxy)cyclohexane, 2,2-bis(4-hydroxymethoxycyclohexyl)propane, 2,2-bis(4-hydroxyethoxycyclohexyl)propane, bis(4-hydroxycyclohexyl)methane, 2,2-bis(4-hydroxycyclohexyl)propane and 3(4),8(9)-tricyclo[5.2.1.0^{2,6}]decanedimethanol. Among these, 2,2-dimethyl-1,3-propanediol, 2,2-diethyl-1,3-propanediol, 2,2-dimethyl-3-hydroxypropyl-2,2′-dimethyl-3-hydroxypropanate, 1,6-hexanediol and 1,4-bis(hydroxymethyl)cyclohexane are preferable.

Further, a compound having three or more functional groups such as trimellitic acid anhydride, glycerin, trimethylolpropane and pentaerythritol may be used as a part of a raw material of the polyester polyol (A) within the range that the characteristics of the polyester resin such as solubility in an organic solvent and coating workability are not impaired.

Examples of the aromatic polyisocyanate compound (B) in the present invention include 2,4-tolylenediisocyanate, 2,6-tolylenediisocyanate, p-phenylenediisocyanate, 4,4′-diphenylmethanediisocyanate, m-phenylenediisocyanate, 3,3′-dimethoxy-4,4′-biphenylenediisocyanate, 2,6-naphthalenediisocyanate, 3,3′-dimethyl-4,4′-biphenylenediisocyanate, 4,4′-diphenylenediisocyanate, 4,4′-diisocyanate diphenyl ether, 1,5-naphthalenediisocyanate, m-xylenediisocyanate, and the like. Among these, 4,4′-diphenylmethanediisocyanate is particularly preferable because it is superior in the dispersibility of the nonmagnetic particles.

The compound (C) to be used in the present invention is not particularly limited as long as it has unsaturated hydrocarbon groups and a functional group which reacts with an isocyanate group and a molecular weight of 500 or less. Examples of the compound (C) include 2-hydroxy-3-acryloyloxydipropylmethacrylate, glyceroldimethacrylate, monohydroxypentaerythritol triacrylate, and the like. This compound (C) is formulated to impart radiation-curability to the polyurethane resin obtained by the reaction. In this case, when a compound having a molecular weight exceeding 500 is used as the compound (C) even if it has unsaturated hydrocarbon groups and a functional group which reacts with an isocyanate group, there is a defect that the glass transition temperature of the polyurethane resin drops, with the result that the bit error rate of the magnetic recording medium increases. Among the aforementioned compounds, it is preferable to use monohydroxypentaerythritol triacrylate as the compound (C) from the viewpoint of exhibiting excellent radiation curability. In addition, though no particular limitation is imposed on the molecular weight of the compound (C) as long as it is 500 or less, the molecular weight is preferably 50 or more.

The polyurethane resin in the present invention which is obtained by reacting the polyester polyol (A), the aromatic polyisocyanate compound (B) and the compound (C) has 50 to 100 eq/t (preferably 50 to 80 eq/t) of metal phosphate groups in its molecule. When the concentration of the metal phosphate group contained in the polyurethane resin is less than 50 eq/t, there is a defect that a center line average roughness Ra of the manufactured magnetic recording medium 1 increases. Further, when the concentration of the metal phosphate group contained in the polyurethane resin exceeds 100 eq/t, the nonmagnetic particles interacts with the unadsorbed metal phosphate group in a coating paint for forming the nonmagnetic layer, to increase the viscosity of the coating paint, thereby giving a hindrance to coatability and increasing the center line average roughness Ra of the magnetic recording medium. The concentration of the above metal phosphate group indicates the value determined in the following manner: 0.1 g of a sample is carbonized at 550° C. in a platinum crucible and dissolved in an acid (specifically hydrochloric acid), and then the concentration of a metal (specifically, sodium) is measured by atomic absorption spectroscopy to calculate the concentration of a polar group by the following equation (the unit represents the number of equivalents per ton of the resin).

Concentration of the metal phosphate group (eq/t)=Concentration of the metal (ppm)/Atomic weight of the contained metal

Processes of introducing the metal phosphate group into the polyurethane resin in the present invention to adjust the content of the metal phosphate group in a molecule to the above range are not particularly limited. For example, it is preferable to use at least one phosphorus compound represented by the following formulae (I) to (vii).

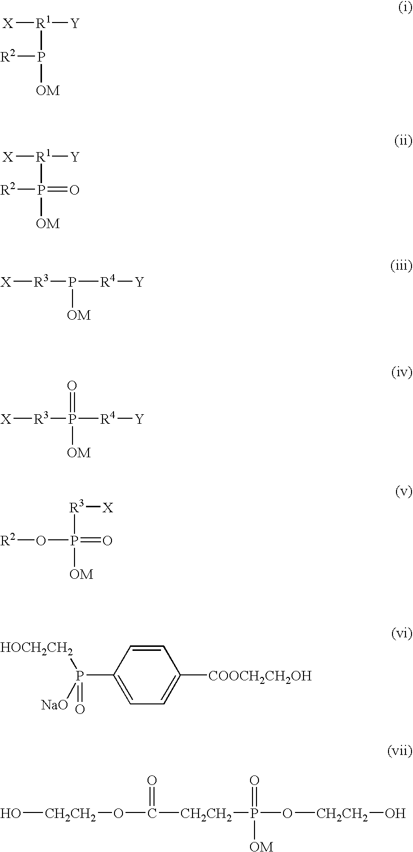

In the above formula, X and Y respectively represent an ester forming functional group such as a hydroxyl group, R¹ represents a trivalent hydrocarbon group having 3 to 10 carbon atoms, R² represents an alkyl group having 1 to 12 carbon atoms, a cycloalkyl group, an aryl group, an alkoxy group having 1 to 12 carbon atoms, a cycloalkoxy group or an aryloxy group, wherein the aryl group and the aryloxy group may be combined with a halogen atom, hydroxy group, —OM¹ (M¹ represents an alkali metal) or an amino group. R³ and R⁴ respectively represent an alkylene group having 1 to 12 carbon atoms, a cycloalkylene group, an arylene group, a group represented by the following formula: —(CH₂—OR⁵)ₘ— (R⁵ represents an alkylene group having 1 to 12 carbon atoms, a cycloalkylene group or an arylene group). m takes any number from 1 to 4. M represents an alkali metal atom and particularly preferably Na.

When the phosphorous compound represented by the above formulae (i) to (vii) is used, it acts well on the nonmagnetic particles (particularly, iron oxide particles having an average major axis length of 150 nm or less as will be described later), whereby it is possible to more improve the dispersibility of the nonmagnetic particles in the nonmagnetic layer 2. If a phosphorus compound represented by the formula (vii) among the above formulae is used, this is particularly preferable with the view of improving the dispersibility.

Examples of the method of introducing the phosphate into the polyurethane resin by using the aforementioned phosphorus compound include a method in which the phosphate is copolymerized with the polyester polyol (A) and a method in which the above phosphorus compound is used directly as a chain extending agent and subjected to polymerization.

The polyurethane resin in the present invention has 800 to 1600 eq/t (preferably 900 to 1500 eq/t) of unsaturated hydrocarbon groups in its molecule. This unsaturated hydrocarbon group is derived from the compound (C) having the aforementioned unsaturated hydrocarbon group and a functional group which reacts with an isocyanate group and a molecular weight of 500 or less. In this case, the unsaturated hydrocarbon group may be bound to either the main chain or branched chain of a skeleton polyurethane resin. Since the polyurethane resin in the present invention has 800 to 1600 eq/t of unsaturated hydrocarbon groups in its molecule, it can be sufficiently cured at a radiation dose of 3 Mrad or less.

If the amount of the unsaturated hydrocarbon group contained in the polyurethane resin is less than 800 eq/t, the polyurethane resin can be insufficiently cured at a radiation dose of 3 Mrad or less, whereas if the amount of the unsaturated hydrocarbon group exceeds 1600 eq/t, the center line average roughness Ra of the manufactured magnetic recording medium increases by curing distortion. It is to be noted that the amount of the above unsaturated hydrocarbon group indicates the value calculated by the following formula from the amount of the raw material used in the production of the polyurethane resin (the unit represents the number of equivalents per ton of the resin).

Amount of unsaturated hydrocarbon group (eq/t)={(Mass of Compound

(C)/Molecular weight of Compound (C)) Mass of Polyester polyol (A)+Weight of

Aromatic polyisocyanate (B)+Weight of Compound (C) (+Weight of Compound (D)

when Compound (D) which will be described later is contained) in polyurethane resin}

×Number of unsaturated hydrocarbon groups in one molecule of Compound (C)×10⁶

In the polyurethane resin in the present invention, the polyester polyol (A) preferably contains 70 to 100 mol % of an aliphatic dicarboxylic acid in the acid component from the viewpoint of dispersibility of the nonmagnetic particles and the compound (C) preferably has 2 to 4 unsaturated hydrocarbon groups in one molecule from the viewpoint of satisfactorily curing by irradiation with a radiation at a dose of 3 Mrad or less. When the amount of the aliphatic dicarboxylic acid contained in the acid component of the polyester polyol (A) is less than 70 mol %, the dispersibility of the nonmagnetic particles is deteriorated and the polyurethane resin tends to be cured insufficiently when irradiated with a radiation at a dose of 3 Mrad or less. When the number of the unsaturated hydrocarbon groups in the compound (C) is one in one molecule, the polyurethane resin tends to be cured insufficiently when irradiated with radiation at a dose of 3 Mrad or less. Further, when the number of the unsaturated hydrocarbon groups in the compound (C) is 4 or more in one molecule, the surface smoothness of the nonmagnetic layer is deteriorated by curing shrinkage and therefore, the surface smoothness of the magnetic layer tends to be deteriorated.

The binder contained in the nonmagnetic layer 2 of the magnetic recording medium 1 of the present invention may be a polyurethane resin obtained by further reacting a compound (D) having a functional group which reacts with an isocyanate group and a molecular weight of 800 or less in addition to the aforementioned polyester polyol (A), aromatic polyisocyanate compound (B) and compound (C). Such a compound (D) contributes to an improvement in the solubility of the polyurethane resin and may be copolymerized in a high ratio when combining with the polyester polyol (A) and aromatic polyisocyanate (B). An increase in the copolymerization ratio of the compound (D) leads to an increase in the concentration of urethane bond groups, making the polyurethane resin more tough. Specifically, a polyurethane resin having both of high solubility in a common solvent and tough mechanical physical properties is obtained by regulating these amounts and ratios. These characteristics for the polyurethane resin contribute to high dispersing ability as a binder for the nonmagnetic layer in the magnetic recording medium and to an improvement in the durability of the magnetic recording medium. When a compound having a molecular weight exceeding 800 is used as the compound (D) even if it is a compound having a functional group which reacts with an isocyanate group, the glass transition temperature of the polyurethane resin drops, with the result that the bit error rate of the magnetic recording medium tends to be increased. Also, though no particular limitation is imposed on the molecular weight of the compound (D) as long as it is 800 or less, the molecular weight is preferably 50 or more.

The compound (D) to be used in the present invention is not particularly limited as long as it is a compound having two or more functional groups which react with an isocyanate group and a molecular weight of 800 or less. Examples of the compound (D) include diol compounds such as 1,2-propylene glycol, 1,3-propylene glycol, 1,3-butylene glycol, 2,3-butylene glycol, 2,2-dimethyl-1,3-propanediol, 3-methyl-1,5-pentanediol, 2,2,4-trimethyl-1,3-pentanediol, 2-ethyl-1,3-hexanediol, 2,2-dimethyl-3-hydroxypropyl-2′,2′-dimethyl-3-hydroxypropanate, 2-normalbutyl-2-ethyl-1,3-propanediol, 3-ethyl-1,5-pentanediol, 3-propyl-1,5-pentanediol, 2,2-diethyl-1,3-propanediol, 3-octyl-1,5-pentanediol, 3-phenyl-1,5-pentanediol and 2,5-dimethyl-3-sodiumsulfo-2,5-hexanediol, and diamine compounds such as 1,2-propanediamine, 1,5-pentamethylenediamine, 1,3-bis(aminomethyl)cyclohexane, 1,2-diaminocyclobutane, 1,2-diaminocyclopentane, 1,2-diaminocycloheptane. Among these, 2,2-dimethyl-1,3-propanediol, 2,2-dimethyl-3-hydroxypropyl 2′,2′-dimethyl-3-hydroxypropanate, 2-normalbutyl-2-ethyl-1,3-propanediol and 2,2-diethyl-1,3-propanediol are preferable in view of dispersibility. Further, the compound (D) may be polyester polyol, polypropylene glycol as long as these compounds respectively have a molecular weight of 800 or less.

If a branched compound having 3 or more functional groups that react with an isocyanate group in one molecule is used as the compound (D), it is effective to improve reactivity in the crosslinking reaction that will be described later. Specifically, examples of the compound (D) include polyols such as trimethylolpropane, glycerin, triethanolamine, pentaerythritol and dipentaerythritol or t-caprolactam adducts or propylene oxide adducts of one of these polyols.

The compound (D) is preferably used in a copolymerization amount falling in such a range where the concentration of urethane bond groups of the polyurethane resin in the present invention does not exceed 4000 eq/10⁶ g. When the concentration of urethane bond groups exceeds 4000 eq/10⁶ g, the mechanical physical properties required for the polyurethane resin can be more improved. However, the solubility in a common solvent is reduced and there is therefore the case where high dispersion performance as the binder for the nonmagnetic layer in the magnetic recording medium cannot be obtained. The concentration of the urethane bond groups may be regulated by the copolymerization amount of the compound (D) for the side chain and the molecular weight of the polyester polyol (A). It is to be noted that the unit of the concentration of the urethane bond group is expressed by the number of equivalents (eq/t) per ton of the resin.

Although the polyurethane resin in the present invention is not limited in its molecular weight, the number average molecular weight is preferably in a range from 5000 to 100000 and more preferably in a range from 10000 to 80000. When the number average molecular weight of the polyurethane resin is less than 5000, there is a fear that the mechanical strength of the obtained nonmagnetic layer is insufficient, bringing about deteriorated running durability. Also, when the number average molecular weight of the polyurethane resin exceeds 100000, the viscosity of the solution is increased, bringing about less operability and also, there is a fear that the dispersibility of the obtained nonmagnetic particles, abrasive agent, and the like is deteriorated. The aforementioned number average molecular weight of the above polyurethane resin indicates the value obtained in the following manner: using gel permeation chromatography (GPC) (manufactured by Waters Corporation), polystyrene is used as a standard substance and tetrahydrofuran is used as a solvent to measure and the peaks of low molecular weight molecules having a number average molecular weight less than 300 are deleted during analysis, to perform data processing of the peaks of macromolecules having a number average molecular weight of 300 or more. No particular limitation is imposed on the method in which the polyester polyol (A), the aromatic polyisocyanate compound (B) and the compound (C) (and the compound (D) according to the need) react in order to obtain the polyurethane resin in the present invention. Examples of the method may include a method in which the raw materials are used in a molten state and a method in which the raw materials are dissolved in a solution. As a reaction catalyst, ferrous octylate, dibutyltin dilaurate, triethylamine or the like may be used. Further, a ultraviolet absorber, a an antihydrolysis agent, antioxidant and the like may be added before, during or after the production of the polyurethane resin.

As the binder for the nonmagnetic layer 2 in the present invention, only the aforementioned polyurethane resin may be used. However, the aforementioned polyurethane resin may be used in combination with conventionally known thermoplastic resins, thermocurable resins and other radiation-curable resins upon use. Examples of these resins which may be used in combination with the polyurethane resin include (meth)acryl resins, polyester resins, vinyl chloride type copolymers, acrylonitrile/butadiene type copolymers, polyamide resins, polyvinylbutyral, nitrocellulose, styrene/butadiene type copolymers, polyvinyl alcohol resins, acetal resins, epoxy type resins, phenoxy type resins, polyether resins, polyfunctional polyethers such as polycaprolactone, polyamide resins, polyimide resins, phenol resins and resins obtained by modifying polybutadiene elastomers or the like into radiation curable types. Among these compounds, vinyl chloride type copolymers are preferable due to particularly excellent dispersibility of the nonmagnetic particles.

The nonmagnetic layer 2 in the magnetic recording medium 1 of the present invention contains the aforementioned polyurethane resin as the binder in which the nonmagnetic particles are dispersed, when it is formed. This nonmagnetic layer 2 is provided with the intention of more improving reliability by improving the electromagnetic physical properties of the thin-layered magnetic layer 3 in the magnetic recording medium 1. According to the magnetic recording medium 1 of the present invention, the aforementioned polyurethane resin is used as the binder, the polyurethane resin can be sufficiently cured at a lower radiation dose (3 Mrad or less) than a conventional dose, making it possible to attain the magnetic recording medium 1 having the nonmagnetic layer 2 having sufficient coating film strength. Because this magnetic recording medium 1 of the present invention can be manufactured at a low radiation dose, showing that it is sufficiently improved in productivity. Also, the present invention has the advantage that the magnetic recording medium 1 which is sufficiently reduced in center line average roughness and has a sufficiently low bit error rate can be attained.

The nonmagnetic particles used in the nonmagnetic layer 2 indicate particles exhibiting no magnetic moment when placed in a magnetic field. Examples of the nonmagnetic particles include, but not limited to, particles of nonmagnetic iron oxide (α-Fe₂O₃), calcium carbonate (CaCO₃), α-alumina (α-Al₂O₃), barium sulfate (BaSO₄), titanium oxide (TiO₂), Cr₂O₃, SiO₂, ZnO, ZrO₂ or SnO₂ and carbon black.

In the present invention, the nonmagnetic particles preferably contains iron oxide (α-Fe₂O₃) particles having an average major axis length of 150 nm or less (more preferably 20 to 130 nm) from the viewpoint of improvement of surface smoothness of the nonmagnetic layer. Here, the average major axis length indicates the value obtained as an average of 400 iron oxide particles selected arbitrarily after the particles of each iron oxide are observed by a microscope.

In the present invention, it is preferable to use needle iron oxide particles having an average major axis length of 150 nm or less. Here, the needle iron oxide particles indicate iron oxide particles having a shape having an aspect ratio of 2 or more. It is particularly preferable to use iron oxide particles having an aspect ratio of 3 to 15 as the nonmagnetic particles. It is to be noted that though a nonmagnetic layer more improved in surface smoothness is obtained with an increase in the above aspect ratio. When the aspect ratio exceeds 15, needle iron oxide particles are easily broken when dispersed and there is therefore a fear that a desired effect is not obtained sufficiently.

Further, in the present invention, the aforementioned needle iron oxide particles having an average major axis length of 150 nm or less may be used in combination with granular iron oxide particles as the nonmagnetic particles. Here, the above granular iron oxide particles indicate iron oxide particles having an aspect ratio less than 2. The use of the above granular iron oxide particles in combination has the advantage that it can reduce the thixotropic characteristics of the coating paint used to form the nonmagnetic layer containing the nonmagnetic particles and the binder and also, it can promote the hardness of the formed nonmagnetic layer. When the above granular iron oxide particles are used, granular iron oxide particles having an average major axis length range preferably from 20 to 150 mm and more preferably from 20 to 130 nm is used from the viewpoint of improvement of surface smoothness of the nonmagnetic layer.

As the nonmagnetic particles in the present invention, the aforementioned iron oxide particles having an average major axis length of 150 nm or less and carbon black are preferably used in combination. Carbon black serves to decrease the surface electric resistance of the magnetic layer 3 formed on the nonmagnetic layer 2 and also serves to retain a lubricant (described later) added in the nonmagnetic layer 2. Further, carbon black serves as a source for supplying a lubricant to the magnetic layer 3 and also, serves to bury the projections of the surface of the base film 4 to thereby improve the surface smoothness of the nonmagnetic layer 2, with the result that the surface smoothness of the magnetic layer 3 can be improved.

When the above iron oxide particles having an average major axis length of 150 nm or less and carbon black are used in combination, the ratio (mass ratio) of this iron oxide particles to carbon black is 95/5 to 10/90. When the mass ratio of carbon black is less than 5, the ability to retain a lubricant to be added is deteriorated and there is therefore a fear of deteriorated durability and also a fear that the surface electric resistance of the magnetic layer is increased or the light transmittance of the magnetic layer becomes high. Also, when the mass ratio of carbon black exceeds 90, there is a tendency that the dispersibility of the nonmagnetic particles is impaired and therefore, desired surface smoothness is scarcely obtained.

Though no particular limitation is imposed on the above carbon black used together with iron oxide particles having an average major axis length of 150 nm or less, it is preferable to use carbon black having an average particle diameter of preferably 10 to 80 nm and more preferably 10 to 60 nm. Further, carbon black used in the present invention has a BET specific surface area (measured, for example, by degassing the nonmagnetic particles and by adsorbing or desorbing a molecule of which the adsorption occupying area is known) of, preferably, 50 to 500 m²/g and more preferably 60 to 250 m²/g from the viewpoint of the optimum dispersion viscosity of the coating paint for forming the nonmagnetic layer. As such carbon black, those selected from furnace carbon black, thermal carbon black, acetylene carbon black and the like with reference to, for example, “Carbon Black Handbook” (edited by Carbon Black Association) may be used singly or as a mixture.

The nonmagnetic layer 2 in the present invention may include α-Al₂O₃ or Cr₂O₃ particles having an average particle diameter of 0.1 to 1.0 μm as the nonmagnetic particles. The α-Al₂O₃ or Cr₂O₃ particles having an average particle diameter of 0.1 to 1.0 μm act as an abrasive agent and when these particles are contained, the strength of the nonmagnetic layer 2 can be improved.

The content of the nonmagnetic particles contained in the nonmagnetic layer 2 in the present invention is preferably in a range from 65 to 90% by weight and more preferably in a range from 70 to 87% by weight in the total composition of the nonmagnetic layer 2 though there is no particular limitation thereto. This is because when the content of the nonmagnetic particles is less than 65% by weight, almost no void is present between the nonmagnetic particles and there is therefore a tendency that the calendering processability is impaired, whereas when the content of the nonmagnetic particles exceeds 90% by weight, there is no resin enough to cover the surface of the nonmagnetic particles and there is a tendency that the kneading ability and dispersibility are impaired.

Also, with regard to the blending ratio of the nonmagnetic particles to binder contained in the nonmagnetic layer 2 in the present invention, the binder is blended in a ratio of preferably 5 to 50 parts by weight and more preferably 10 to 30 parts by weight with respect to 100 parts by weight of the nonmagnetic particles but not particularly limited to this ratio. When the binder is less than 5 parts by weight with respect to 100 parts by weight of the nonmagnetic particles, there is a tendency that the kneading ability and dispersibility are impaired, whereas when the ratio of the binder exceeds 50 parts by weight with respect to 100 parts by weight of the nonmagnetic particles, almost no void is present between the nonmagnetic particles and there is therefore a tendency that the calendering processability is impaired.

The nonmagnetic layer 2 in the present invention may be formed in the following manner. Specifically, a coating paint containing the aforementioned nonmagnetic particles and binder is prepared and applied to one surface of the base film 4 to form a coating film. Then, the coating film is irradiated with radiation to cure the polyurethane resin in the coating film, thereby forming the nonmagnetic layer 2. The coating paint for forming this nonmagnetic layer 2 is prepared by adding an organic solvent to the aforementioned nonmagnetic particles and binder. No particular limitation is imposed on the organic solvent to be used. As the organic solvent, one or two or more types appropriately selected from ketone type solvents such as methyl ethyl ketone (MEK), methyl isobutyl ketone and cyclohexanone and aromatic solvents such as toluene may be used. The amount of the organic solvent to be added may be designed to be about 100 to 1900 parts by weight with respect to 100 parts by weight of the total amount of the solid (nonmagnetic particles) and binder.

In the coating paint used to form the nonmagnetic layer 2, a lubricant, dispersant and other various additives besides the aforementioned nonmagnetic particles and binder may be added according to the need to the extent that the effect of the present invention is not impaired. Examples of the lubricant include known proper lubricants such as higher fatty acids, higher fatty acid esters, paraffin and fatty acid amides. Also, examples of the dispersant may include known surfactants such as aromatic acids, higher fatty acids, acid group-containing polymers and amine group-containing polymers.

Examples of the radiation used to cure the polyurethane resin contained as the binder in the nonmagnetic layer 2 may include electron beams, γ-rays, β-rays and ultraviolet rays. Among these, electron beams are preferable because they have high transmittance for the coating film. Although the polyurethane resin in the present invention can be sufficiently cured even at a radiation dose of 3 Mrad or less as mentioned above, the radiation dose of radiation is preferably 1 to 10 Mrad and more preferably 2 to 7 Mrad. Also, the radiation energy (acceleration voltage) of the radiation is preferably designed to be 100 kV or more. Moreover, the radiation is preferably applied before winding after the coating and drying operations. However, the radiation may be applied after winding.

The nonmagnetic layer 2 is not particularly limited in thickness. The thickness of the nonmagnetic layer 2 is preferably 2.5 μm or less and more preferably in a range from 0.1 to 2.3 μm. Even if the thickness of the nonmagnetic layer 2 is increased to a thickness exceeding 2.5 μm, an improvement in performance is not expected and there is therefore a fear that the thickness of the nonmagnetic layer 2 tends to be ununiform when it is formed, and strict requirements are needed for applying the coating paint, bringing about deteriorated surface smoothness.

In the magnetic recording medium 1 of the present invention, the magnetic layer 3 formed on the nonmagnetic layer 2 contains magnetic particles and a binder. Here, the magnetic particles used in the magnetic layer 3 indicate particles exhibiting a magnetic moment when placed in a magnetic field. As such magnetic particles, ferromagnetic particles, for example, metal alloy particles or hexagonal plate particles may be used, but not particularly limited to these particles.

As the metal alloy particles, those formed of alloys of Fe, Co, Pt, Cr, Nd or the like may be used. Among these particles, particles of alloys of Fe or Co are preferable from the viewpoint of attaining coercive force and saturation magnetization at the same time. Rare earth metal elements such as Ni, Zn, Co, Al, Si and Y may be added as additional elements according to the object in the metal alloy particles. The metal alloy particles preferably have an average major axis length of 0.03 to 0.3 μm, an average minor axis length of 10 to 40 nm and an aspect ratio of 1.2 to 20 because particulate noises in high-density recording can be reduced. Also, if metal alloy particles having a coercive force Hc of 119.4 to 238.7 kA/m (1500 to 3000 Oe) and a saturation magnetization σs of 110 to 160 Am²/kg (110 to 160 emu/g) are used, this is desirable because the obtained magnetic recording medium can be made to have a coercive force Hc range from 119.4 to 278.7 kA/m (1500 to 3500 Oe). Here, the average major axis length, average minor axis length and aspect ratio of the metal alloy particles respectively indicate the values obtained as an average of 400 metal alloy particles selected arbitrarily after each metal alloy particle is observed by a microscope. Also, the coercive force Hc and saturation magnetization σs of the metal alloy particles indicate the values measured by, for example, VSM (Vibrating Sample Magnetometer).

As the hexagonal plate particles, particles of made of materials such as substitution products or Co substitution products of barium ferrite, strontium ferrite, lead ferrite and calcium ferrite may be used. Among these particles, hexagonal plate particles formed of barium ferrite are preferable from the viewpoint of high coercive force. The hexagonal plate particles may be those to which rare earth metals such as Ni, Co, Ti, Zn or Sn are added as an added element according to the object. These hexagonal plate particles preferably have an average plate particle diameter of 20 to 80 nm and a plate ratio of 2 to 7 because such particles reduce particulate noises in high-density recording. Further, if hexagonal plate particles having a coercive force Hc of 79.6 to 302.4 kA/m (1000 to 3800 Oe) and a saturation magnetization σs of 50 to 70 Am²/kg (50 to 70 emu/g) are used, this is desirable because the obtained magnetic recording medium can be made to have a coercive force Hc range from 79.6 to 318.3 kA/m (1000 to 4000 Oe). Here, the average plate particle diameter and plate ratio of the hexagonal plate particles respectively indicate the value obtained as an average of 400 hexagonal plate particles selected arbitrarily after each hexagonal plate particle is observed by a microscope. Also, the coercive force Hc and saturation magnetization σs of the hexagonal plate particles indicate the values measured in the same manner as in the case of the above coercive force Hc and saturation magnetization σs of the metal alloy particles.

In the magnetic layer 3 of the present invention, the content of the magnetic particles is, but not particularly limited to, preferably in a range from 70 to 90% by weight and more preferably in a range from 70 to 80% by weight in the total composition of the magnetic layer 3. When the content of the magnetic particles is less than 70% by weight, there is a fear that it is difficult to obtain a high reproduction output in the obtained magnetic recording medium 1, whereas when the content of the magnetic particles exceeds 90% by weight, the content of the binder is reduced and there is therefore a fear that the magnetic layer 3 is easily peeled off when the obtained magnetic recording medium 1 is run.

As the binder used in the magnetic layer 3 in the present invention, conventionally known and appropriate thermoplastic resins, thermocurable resins, other radiation-curable resins or mixtures of these resins may be preferably used, but not particularly limited to these resins. Further, the polyurethane resin mentioned above as the binder used in the nonmagnetic layer 2 may be used singly or in combinations of other resins as the binder of the magnetic layer 3.

As to the blending ratio of the magnetic particles to the binder contained in the magnetic layer 3 in the present invention, the binder is blended preferably in a ratio of 5 to 40 parts by weight and more preferably in a ratio of 10 to 30 parts by weight with respect to 100 parts by weight of the magnetic particles. When the ratio of the binder is less than 5 parts by weight with respect to 100 parts by weight of the magnetic particles, the strength of the magnetic layer 3 is dropped and there is therefore a tendency that the running durability is easily deteriorated, whereas when the ratio of the binder exceeds 40 parts by weight with respect to 100 parts by weight of the magnetic particles, the magnetic particles contained in the magnetic layer 3 is too small, and the electromagnetic transformation characteristics of the obtained magnetic recording medium 1 tend to be deteriorated.

The magnetic layer 3 in the present invention may be formed by adding an organic solvent to the magnetic particles and the binder to prepare a coating paint, which is then applied to the nonmagnetic layer 2 which has been already formed on the base film 4, followed by drying. No particular limitation is imposed on the organic solvent to be used. As the organic solvent, one or two or more types appropriately selected from ketone type solvents such as methyl ethyl ketone (MEK), methyl isobutyl ketone and cyclohexanone and aromatic solvents such as toluene may be used. The amount of the organic solvent to be added may be designed to be about 100 to 1900 parts by weight with respect to 100 parts by weight of the total amount of the solid (ferromagnetic particles and various inorganic particles) and binder.

In the coating paint used to form the nonmagnetic layer 3, various additives such as a crosslinking agent (curing agent), abrasive agent, dispersant (surfactant) and lubricant may be added. As these additives, conventionally known appropriate types may be used. For example, in the case of using a thermoplastic resin as the binder, examples of the crosslinking agent include various polyisocyanates. When the crosslinking agent is added, it is formulated in an amount of 10 to 30 parts by weight with respect to 100 parts by weight of the binder.

The thickness of the magnetic layer 3 in the magnetic recording medium 1 of the present invention is, but not particularly limited to, preferably 300 nm or less, more preferably in a range from 10 to 300 nm and particularly preferably 20 to 300 nm. When the thickness of the magnetic layer 3 exceeds 300 nm, there is a fear as to increases in self-demagnetization loss and in thickness loss. Also, when the thickness of the magnetic layer 3 is less than 10 nm, there is a tendency that coating defects are caused, leading to easy dropout of the magnetic layer.

The magnetic recording medium 1 of the present invention is obtained by forming the aforementioned nonmagnetic layer 2 and the magnetic layer 3 on one surface of the base film 4 which is a nonmagnetic support. As the base film 4, an appropriate one may be selected from various flexible materials, for example, known resin films including polyester resins such as polyethylene terephthalate and polyethylene naphthalate, polyamide resins or aromatic polyamide resins or films obtained by laminating these resins. The thickness of the film and the like are those falling in known ranges and no particular limitation is imposed on it.

The method of forming the nonmagnetic layer 2 and the magnetic layer 3 on the base film 4 may be a wet-on-wet coating method in which after a coating paint for forming the nonmagnetic layer 2 is formed on the base film 4, a coating paint for forming the magnetic layer 3 is applied while the nonmagnetic layer 2 is put in a wetted state, or may be a wet-on-dry coating method in which the coating paint for forming the magnetic layer 3 is applied after the nonmagnetic layer 2 is dried. It is preferable from the viewpoint of an improvement in recording density to form the nonmagnetic layer 2 and the magnetic layer 3 by the wet-on-dry coating because the surface smoothness of both the nonmagnetic layer 2 and the magnetic layer 3 can be controlled with high preciseness. It is particularly preferable to form the magnetic layer 3 by coating after the polyurethane resin contained as the binder in the nonmagnetic layer 2 is cured by applying a radiation.

In the magnetic recording medium 1 shown in FIG. 1, a back-coat layer 5 is formed on the other surface which is the side opposite to the surface of the base film 4 on which surface the nonmagnetic layer 2 and the magnetic layer 3 are formed. The back-coat layer 5 serves to improve the tape-running characteristics of the magnetic recording medium 1 and also to serve to prevent the base film from being scratched (abraded) and to prevent the magnetic recording medium 1 from being electrified.

In the formation of the back-coat layer 5, conventionally known proper thermoplastic resins, thermocurable resins, other radiation-curable resins or mixtures of these resins may be preferably used without any particular limitation. The aforementioned polyurethane resin may be used singly or in combinations with other resins as the binder used in the nonmagnetic layer 2 to form the back-coat layer 5.

The back-coat layer 5 preferably contains 30 to 80% by weight of carbon black from the viewpoint of imparting antistatic properties. There is no particular limitation to such carbon black and the same carbon black used as the nonmagnetic particles in the nonmagnetic layer 2 may be used. Also, the back-coat layer 5 may be formulated with nonmagnetic inorganic particles such as various abrasive agents, dispersants such as surfactants, lubricants such as higher fatty acid, fatty acid ester and silicon oil and other various additives.

The thickness of the back-coat layer 5 is 0.1 to 1.0 μm and preferably 0.2 to 0.9 μm. When the thickness of the back-coat layer 5 exceeds 1.0 μm, the friction with a medium slide contact path is too increased and the running stability of the magnetic recording medium 1 tends to be deteriorated. Also, when the thickness of the back-coat layer 5 is less than 0.1 μm, there is a fear that the coating abrasion of the back-coat layer 5 is easily caused when the magnetic recording medium 1 is running.

It is to be noted that the magnetic recording medium 1 which is an example shown in FIG. 1 is only shown as one preferred example in a strict sense and the magnetic recording medium of the present invention is not limited to the structure shown in FIG. 1. For example, an undercoat layer (easily adhesive layer) may be disposed between the base film and the nonmagnetic layer with the intention of improving the adhesiveness of the nonmagnetic layer to the base film. The undercoat layer may be formed using, for example, a polyester resin, acryl resin, melamine resin or the like as an easily adhesive coating agent.

The present invention will be described in more detail by way of examples and comparative examples, which are, however, not intended to be limiting of the present invention. The abbreviations in examples are as follows.

AA: Adipic acid

SA: Sebacic acid

IA: Itaconic acid

TPA: Terephthalic acid

IPA: Isophthalic acid

EG: Ethylene glycol

HD: 1,6-hexanediol

DMH: 2-butyl-2-ethyl-1,3-propanediol

NPG: 2,2-dimethyl-1,3-propanediol

HPN: 2,2-dimethyl-3-hydroxypropyl-2′,2′-dimethyl-3-hydroxypropanate

MDI: 4,4′-diphenylmethanediisocyanate

IPDI: Isophoronediisocyanate

PETA: Monohydroxypentaerythritol triacrylate (3 double bonds in one molecule)

701A: 2-hydroxy-3-acryloyloxypropylmethacrylate (2 double bonds in one molecule, manufactured by Shin-Nakamura Chemical Co., Ltd.)

Phosphorus compound: Chemical Formula (vii)

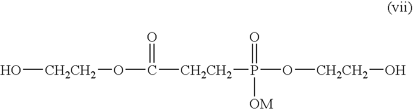

MEK: Methyl ethyl ketone

A process of measuring the physical properties of the resin will be described.

(1) Hydroxyl Value of Polyester Polyol (A)

50 g of polyester polyol was dissolved in a mixture solvent of 120 g of MEK, to which 70 g of MDI was then added, and the mixture was reacted at 70° C. for 2 hours. Then, the concentration of a residual isocyanate group was measured quantitatively by titration to determine its hydroxyl value.

(2) Number Average Molecular Weight

The number average molecular weight of a sample was measured by gel permeation chromatography (GPC) (manufactured by Waters Corporation) using polystyrene as a standard substance and tetrahydrofuran as a solvent. In this case, the peaks of low molecular weight molecules having a number average molecular weight less than 300 were deleted during analysis, to perform data processing of the peaks of macromolecules having a number average molecular weight of 300 or more to obtain the number average molecular weight.

(3) Composition Analysis

¹H-NMR analysis was performed in a chloroform D solvent using a nuclear magnetic resonance (NMR) (trade name: Gemini 200, manufactured by Varian, Inc.) to determine the percentage composition from the integral ratio obtained.

(4) Glass Transition Temperature

A polyurethane resin film having a thickness of 30 μm was produced and cut into a size of 4 mm×15 mm. Then, the dynamic viscoelasticity of the film was measured using a dynamic viscoelasticity measuring device (trade name: DVA-220, manufactured by IT Keisoku Seigyo Co., Ltd.) at a frequency of 10 Hz, a measuring temperature range of 30 to 180° C. and a temperature rise rate of 4° C./min. In the refraction point of storage elastic modulus (E′), a temperature at the point where an extended line of a base line at the glass transition temperature or less and a tangential line showing the maximum inclination at a point above the refraction point are intersected with each other is defined as a glass transition temperature.

(5) Concentration of a Metal Phosphate Group

0.1 g of a sample was carbonized and dissolved in an acid, and then, atomic absorption analysis was performed to determine the concentration of the metal phosphate group. The following equation was used to define the concentration of polar groups. In this example, the concentration of sodium was measured.

Metal phosphate group concentration (eq/t)=Metal concentration (ppm)/Atomic amount of the contained metal

(6) Amount of Unsaturated Hydrocarbons

This was calculated from the weight of the raw material used in the production of the polyurethane resin according to the following calculation equation.

Amount of unsaturated hydrocarbons (eq/t)={(Mass of Compound (C) having

unsaturated hydrocarbon groups/Molecular weight of Compound (C) having

unsaturated hydrocarbon groups)/Mass of Polyester polyol (A) blended in polyurethane

resin+Mass of Polyisocyanate (B)+Mass of Compound (C) having unsaturated

hydrocarbons+Mass of Compound (D)}×Number of unsaturated hydrocarbon groups

contained in one molecule×10⁶

### SYNTHETIC EXAMPLE 1

### Synthesis (1) of Polyester Polyol (A)

A reactor equipped with a thermometer, a stirrer and a Liebig condenser was charged with 142 parts by weight of adipic acid, 8 parts by weight of a phosphorous compound, 30 parts by weight of ethylene glycol, 71 parts by weight of 1,6-hexanediol, 104 parts by weight of 2,2-dimethyl-1,3-propanediol and 0.2 part by weight of tetrabutyl titanate, and the mixture was heated at 180 to 220° C. for 180 minutes and subjected to an esterification reaction. Then, the pressure in the reaction system was reduced to 5 mm Hg over 20 minutes, while the temperature of the system was raised to 240° C. Furthermore, the pressure in the system was gradually decreased until the pressure was 0.3 mm Hg or less after 10 minutes. The mixture was subjected to a polymerization condensation reaction at 240° C. for 30 minutes. As to the resulting polyester polyol (referred to polyester polyol (a)), the resin composition (molar ratio), hydroxyl value and concentration of a metal phosphate group are shown in Table 1.

### SYNTHETIC EXAMPLES 2 AND 3

### Synthesis (2) and (3) of Polyester Polyols (A)

Polyester polyols were respectively synthesized in the same manner as in Synthetic Example 1 except that the resin composition was altered to those shown in Table 1. As to the resulting polyester polyols (referred to polyester polyols (b) and (c)), the resin composition (molar ratio), hydroxyl value and concentration of a metal phosphate group are shown in Table 1.

### SYNTHETIC EXAMPLE 4

### Synthesis (4) of Polyester Polyol (A)

A reactor equipped with a thermometer, a stirrer and a Liebig condenser was charged with 124 parts by weight of adipic acid, 66 parts by weight of a phosphorous compound, 208 parts by weight of 2,2-dimethyl-1,3-propanediol and 0.2 part by weight of tetrabutyl titanate, and the mixture was heated at 180 to 220° C. for 180 minutes and subjected to an esterification reaction. Then, the pressure in the reaction system was reduced to 5 mm Hg over 5 minutes. As to the resulting polyester polyol (referred to polyester polyol (d)), the resin composition (molar ratio), hydroxyl value and concentration of a metal phosphate group are shown in Table 1.

### SYNTHETIC EXAMPLE 5

### Synthesis (5) of Polyester Polyol (A)

A reactor equipped with a thermometer, a stirrer and a Liebig condenser was charged with 97 parts by weight of dimethyl terephthalate, 91 parts by weight of dimethyl isophthalate, 7 parts by weight of a phosphorous compound, 83 parts by weight of ethylene glycol, 77 parts by weight of 2,2-dimethyl-1,3-propanediol and 0.2 parts by weight of tetrabutyl titanate, and the mixture was heated at 180 to 220° C. for 180 minutes and subjected to an esterification reaction. Then, the pressure in the reaction system was reduced to 5 mm Hg over 20 minutes, while the temperature of the system was raised to 240° C. Furthermore, the pressure in the system was gradually decreased until the pressure was 0.3 mm Hg or less after 10 minutes. The mixture was subjected to a polymerization condensation reaction at 240° C. for 30 minutes. As to the resulting polyester polyol (referred to polyester polyol (e)), the resin composition (molar ratio), hydroxyl value and concentration of a metal phosphate group are shown in Table 1.

TABLE 1

| | | Polyester polyol (A) | | | | |
|---|---|---|---|---|---|---|
| Structural component (molar ratio) | | (a) | (b) | (c) | (d) | (e) |
| Dibasic | AA | 97 | — | 100 | 95 | — |
| acid | SA | — | 90 | — | — | — |
| | IA | — | 5 | — | — | — |
| | TPA | — | — | — | — | 50 |
| | IPA | — | — | — | — | 47 |
| | Phosphorus compound | 3 | 5 | — | 5 | 3 |
| Glycol | EG | 10 | 8 | — | — | 48 |
| | HD | 30 | — | — | — | — |
| | NPG | 60 | 92 | 100 | 100 | 52 |
| | HPN | — | — | — | — | — |

| | | | | | |
|---|---|---|---|---|---|
| Hydroxy value | 1100 | 900 | 1000 | 6300 | 1000 |
| Concentration of metal | 138 | 181 | 0 | 156 | 139 |
| phosphate group (Eq/t) | | | | | |

### PRODUCTION EXAMPLE 1

### Synthesis of Polyurethane Resin (I)

A reactor equipped with a thermometer, a stirrer and a Liebig condenser was charged with 100 parts by weight of polyester polyol (a) and 300 parts by weight of toluene to dissolve polyester polyol (a), and the mixed solution was heated to 120° C. to distill water together with toluene in the system in a azeotropic step (100 parts by weight of toluene was distilled). The residue was dissolved in 30 parts by weight of 2-butyl-2-ethyl-1,3-propanediol, 20 parts by weight of monohydroxypentaerythritol triacrylate and 200 parts by weight of methyl ethyl ketone. 0.05 part by weight of phenothiazine was added to the mixed solution, which was then stirred. Then, 65 parts by weight of 4,4′-diphenylmethanediisocyanate was added to the solution and 0.05 part by weight of dibutyltin dilaurate was added as a catalyst to react the mixture at 45° C. for 12 hours, thereby obtaining a polyurethane resin (I). As to the resulting polyurethane resin (I), the number average molecular weight, the glass transition temperature, the concentration of a metal phosphate group and the amount of unsaturated hydrocarbon groups are shown in Table 2.

### PRODUCTION EXAMPLE 2

### Synthesis of Polyurethane Resin (II)

A polyurethane resin (II) was synthesized in the same manner as in Production Example 1 except that the resin composition was altered to that shown in Table 2. As to the resulting polyurethane resin (II), the number average molecular weight, the glass transition temperature, the concentration of a metal phosphate group and the amount of unsaturated hydrocarbon groups are shown in Table 2.

### PRODUCTION EXAMPLE 3

### Synthesis of Polyurethane Resin (III)

A reactor equipped with a thermometer, a stirrer and a Liebig condenser was charged with 100 parts by weight of polyester polyol (c), 2.5 parts by weight of a phosphorous compound (chemical formula (vii)) and 263 parts by weight of toluene to dissolve polyester polyol (c), and the mixed solution was heated to 120° C. to distill water together with toluene in the system in a azeotropic step (100 parts by weight of toluene was distilled). The residue was dissolved in 20 parts by weight of 2-butyl-2-ethyl-1,3-propanediol, 20 parts by weight of monohydroxypentaerythritol triacrylate and 163 parts by weight of methyl ethyl ketone. 0.05 part by weight of phenothiazine was added to the mixed solution, which was then stirred. Then, 33 parts by weight of 4,4′-diphenylmethanediisocyanate was added to the solution and 0.05 part by weight of dibutyltin dilaurate was added as a catalyst to react the mixture at 45° C. for 12 hours, thereby obtaining a polyurethane resin (III). As to the resulting polyurethane resin (III), the resin composition, the number average molecular weight, the glass transition temperature, the concentration of a metal phosphate group and the amount of unsaturated hydrocarbon groups are shown in Table 2.

### PRODUCTION EXAMPLE 4

### Synthesis of Polyurethane Resin (IV)

A polyurethane resin (IV) was synthesized in the same manner as in Production Example 1 except that the resin composition was altered to that shown in Table 2. As to the resulting polyurethane resin (IV), the number average molecular weight, the glass transition temperature, the concentration of a metal phosphate group and the amount of unsaturated hydrocarbon groups are shown in Table 2.

### COMPARATIVE PRODUCTION EXAMPLE 1

### Synthesis of Polyurethane Resin (V)

A polyurethane resin (V) was synthesized in the same manner as in Production Example 1 except that the resin composition was altered to that shown in Table 2. As to the resulting polyurethane resin (V), the number average molecular weight, the glass transition temperature, the concentration of a metal phosphate group and the amount of unsaturated hydrocarbon groups are shown in Table 2.

### COMPARATIVE PRODUCTION EXAMPLE 2

### Synthesis of Polyurethane Resin (VI)

A polyurethane resin (VI) was synthesized in the same manner as in Production Example 1 except that the resin composition was altered to that shown in Table 2. As to the resulting polyurethane resin (VI), the number average molecular weight, the glass transition temperature, the concentration of a metal phosphate group and the amount of unsaturated hydrocarbon groups are shown in Table 2.

### COMPARATIVE PRODUCTION EXAMPLE 3

### Synthesis of Polyurethane Resin (VII)

A polyurethane resin (VII) was synthesized in the same manner as in Production Example 1 except that the resin composition was altered to that shown in Table 2. As to the resulting polyurethane resin (VII), the number average molecular weight, the glass transition temperature, the concentration of a metal phosphate group and the amount of unsaturated hydrocarbon groups are shown in Table 2.

### COMPARATIVE PRODUCTION EXAMPLE 4

### Synthesis of Polyurethane Resin (VIII)

A polyurethane resin (VIII) was synthesized in the same manner as in Production Example 1 except that the resin composition was altered to that shown in Table 2. As to the resulting polyurethane resin (VIII), the number average molecular weight, the glass transition temperature, the concentration of a metal phosphate group and the amount of unsaturated hydrocarbon groups are shown in Table 2.

TABLE 2

| | | | | | | | | | | | | Concen- | |
|---|---|---|---|---|---|---|---|---|---|---|---|---|---|
| | | | | | | | | | | | | tration | Amount of |
| | | | | | | | | | | Number | | of metal | unsaturated |
| | | Polyester polyol | | Polyisocyanate | | Compound | | Compound | | average | | phosphate | hydrocarbon |
| | Polyurethane | (A) | | (B) | | (C) | | (D) | | molecular | Tg | group | group |
| | resin | Type | Parts | Type | Parts | Type | Parts | Type | Parts | weight | (° C.) | (eq/t) | (eq/t) |
| Production | (I) | (a) | 100 | MDI | 65 | PETA | 20 | DMN | 30 | 38000 | 15 | 64 | 940 |
| Example 1 | | | | | | | | | | | | | |
| Production | (II) | (b) | 100 | MDI | 54 | PETA | 25 | HPN | 30 | 35000 | 3 | 87 | 1200 |
| Example 2 | | | | | | | | | | | | | |
| Production | (III) | (c) | 100 | MDI | 37 | PETA | 20 | Phosphorus | 2.5 | 30000 | 0 | 53 | 1120 |
| Example 3 | | | | | | | | compound | | | | | |
| | | | | | | | | DMH | 20 | | | | |
| Production | (IV) | (d) | 100 | MDI | 92 | 701A | 30 | — | — | 23000 | 40 | 70 | 1260 |
| Example 4 | | | | | | | | | | | | | |
| Comparative | (V) | (a) | 100 | MDI | 64 | PETA | 15 | DMH | 30 | 32000 | 11 | 66 | 720 |
| Production | | | | | | | | | | | | | |
| Example 1 | | | | | | | | | | | | | |
| Comparative | (VI) | (e) | 100 | MDI | 27 | PETA | 15 | HPN | 10 | 29000 | 65 | 91 | 990 |
| Production | | | | | | | | | | | | | |
| Example 2 | | | | | | | | | | | | | |
| Comparative | (VII) | (c) | 100 | MDI | 32 | PETA | 20 | Phosphorus | 1.5 | 27000 | 0 | 33 | 1160 |
| Production | | | | | | | | compound | | | | | |
| Example 3 | | | | | | | | DMH | 20 | | | | |
| Comparative | (VIII) | (c) | 100 | MDI | 20 | PETA | 30 | Phosphorus | 5 | 21000 | −5 | 117 | 1950 |
| Production | | | | | | | | compound | | | | | |
| Example 4 | | | | | | | | | | | | | |

(Synthesis of a Vinyl Chloride Resin)

In a reactor equipped with a thermometer, a stirrer and a condenser, 100 parts by weight of MR110 was dissolved in 245 parts by weight of methyl ethyl ketone. Then, phenothiazine and hydroquinone were mixed in an amount of 200 ppm with respect to the following acryl compound. Thereafter, 5 parts by weight of 2-isocyanate ethylmethacrylate (MOI) and 1000 ppm of di-n-butyltin dilaurate used as a urethanating catalyst with respect to the above isocyanate compound were added and the mixture was stirred at a reaction temperature of 60° C. for 8 hours. The obtained radiation-curable vinyl chloride resin was measured to determine that the number average molecular weight of 25000 and the glass transition temperature was 60° C.

### EXAMPLE 1

### Preparation of a Coating Paint for Forming a Nonmagnetic Layer

Nonmagnetic particles (1): Iron oxide (α-Fe₂O₃) particles (average major axis length: 100 nm, crystallite diameter: 12 nm, aspect ratio: 8) 80.0 parts by weight

Nonmagnetic particles (2): Carbon black (trade name: #950B, manufactured by Mitsui Chemicals, Inc., average particle diameter: 17 nm, BET specific surface area: 250 m²/g, DBP oil absorption amount: 70 ml/100 g, pH: 8) 20.0 parts by weight

Vinyl chloride resin (degree of polymerization: 300, content of sulfur used in potassium persulfate: 0.6% by weight) 12.0 parts by weight (one synthesized in the above manner)

Polyurethane resin (I) (metal phosphate group (═PO₂Na): 64 eq/t, mol % of the compound (C): 5 mol %, skeleton: aliphatic skeleton) 10.0 parts by weight

Dispersant: Phosphoric acid type surfactant (trade name: RE610, manufactured by Toho Chemical Industry Co., Ltd.) 3.2 parts by weight

Abrasive agent: α-alumina (trade name: HIT60A, manufactured by Sumitomo Chemical Co., Ltd., average particle diameter: 0.18 μm) 5.0 parts by weight

The above materials were mixed such that the solid concentration was 33% (mass percentage) and the ratio of solvents was MEK/toluene/cyclohexane=2/2/1 (mass ratio) and kneaded in a kneader. Then, the kneaded mixture was dispersed in a horizontal type pin mill with 0.8 mm zirconia beads filled at a packing ratio of 80 (void ratio: 50% by volume). Moreover, the following lubricants were added.

Lubricant: Fatty acid (trade name: NAA180, manufactured by NOR corporation) 0.5 part by weight

Lubricant: Fatty acid amide (trade name: Fatty Acid Amide S, manufactured by Kao Corporation) 0.5 part by weight

Lubricant: Fatty acid ester (trade name: NIKKOOLBS, Nikko Chemicals Co., Ltd.) 1.0 part by weight

The above additives were added and diluted such that the solid concentration was 25% (mass percentage) and the ratio of solvents was MEK/toluene/cyclohexane=2/2/1 (mass ratio) and then dispersed. The obtained coating paint was filtered using a filter having an absolute filter precision of 1.0 μm to prepare a coating paint for forming a nonmagnetic layer.

(Preparation of a Coating Paint for Forming a Magnetic Layer)

Magnetic particles: Fe type needle ferromagnetic particles (Fe/Co/Al/Y=100/24/5/8 (atomic ratio), Hc: 188 kA/m, σs: 140 mA²/kg, BET specific surface area: 50 m²/g, average major axis length: 0.10 μm) 100.0 parts by weight

Vinyl chloride resin: Vinyl chloride copolymer (trade name: MR110, manufactured by Zeon Corporation) 10.0 parts by weight

Polyurethane resin: Polyester urethane (trade name: UR8300, manufactured by Toyobo Co., Ltd.) 6.0 parts by weight

Dispersant: Phosphoric acid type surfactant (trade name: RE610, manufactured by Toho Chemical Industry Co., Ltd.) 3.0 parts by weight

Abrasive agent: α-alumina (trade name: HIT60A, manufactured by Sumitomo Chemical Co., Ltd., average particle diameter: 0.18 μm) 10.0 parts by weight

The above materials were mixed such that the solid concentration was 30% (mass percentage) and the ratio of solvents was MEK/toluene/cyclohexane=4/4/2 (mass ratio) and kneaded in a kneader. Then, for pre-dispersing, the kneaded mixture was dispersed in a horizontal type pin mill with 0.8 mm zirconia beads filled at a packing ratio of 80% (void ratio: 50% by volume).

Thereafter, the mixture was diluted such that the solid concentration was 15% (mass percentage) and the ratio of solvents was MEK/toluene/cyclohexane=22.5/22.5/55 (mass percentage) and then dispersed as finish dispersion. After 4 parts by weight of a curing agent (trade name: CORONATE L, manufactured by Nippon Polyurethane Industry Co., Ltd.) was added to the obtained coating paint, the solution was filtered using a filter having an absolute filter precision of 0.5 μm to prepare a coating paint for forming a magnetic layer.

(Preparation of a Coating Paint for Forming a Back-Coat Layer)

Carbon black (trade name: BP-800, manufactured by Cabot Corporation, average particle diameter: 17 nm, DBP oil absorption amount: 68 ml/100 g, BET specific surface area: 210 m²/g) 75.0 parts by weight

Carbon black (trade name: BP-130, manufactured by Cabot Corporation, average particle diameter: 75 nm, DBP oil absorption amount: 69 ml/100 g, BET specific surface area: 25 m²/g) 15.0 parts by weight

Calcium carbonate particles (trade name: HAKUENKA O, manufactured by Shiraishi Kogyo Kaisha, Ltd., average particle diameter: 30 nm) 10.0 parts by weight

Nitrocellulose (trade name: BTH 1/2, manufactured by Asahi Chemical Industry Co., Ltd.) 65.0 parts by weight

Polyurethane resin (aliphatic polyester diol/aromatic polyester diol=43/57) 35.0 parts by weight

The above materials except for a part of the organic solvent were mixed such that the solid concentration was 30% (mass percentage) and the ratio of solvents was MEK/toluene/cyclohexane=1/1/1 (mass ratio) and sufficiently kneaded in a highly viscous state by a kneader. Then, an appropriate amount of the organic solvent was added to sufficiently stir the mixture by a dissolver and then the above materials were kneaded in a kneader. Then, for pre-dispersing, the kneaded mixture was dispersed in a horizontal type pin mill with 0.8 mm zirconia beads filled at a packing ratio of 80% (void ratio: 50% by volume).

Thereafter, the mixture was diluted such that the solid concentration was 10% (mass percentage) and the ratio of solvents was MEK/toluene/cyclohexane=50.0/40.0/10.0 (mass ratio) and then dispersed as finish dispersion. After 10 parts by weight of a curing agent (trade name: CORONATE L, manufactured by Nippon Polyurethane Industry Co., Ltd.) was added to the obtained coating paint, the solution was filtered using a filter having an absolute filter precision of 0.5 μm to prepare a coating paint for forming a back-coat layer.

(Nonmagnetic Layer 2 Forming Step)

The coating paint for forming the aforementioned nonmagnetic layer was applied to one surface of a 6.2-μm-thick base film 4 (polyethylene naphthalate film) by an extrusion coating method by a nozzle such that the thickness after calendering processing was 2.0 μm and then dried. Then, a calender obtained by combining a plastic roll and a metal roll was used to carry out processing at the number of nips of four times, a processing temperature of 100° C. and a line pressure of 3500 N/cm, and further, the coating layer was irradiated with electron beams at a dose of 2.0 Mrad and an acceleration voltage of 200 kV, to form a nonmagnetic layer 2.

(Magnetic Layer 3 Forming Step)

A coating paint for forming the aforementioned nonmagnetic layer 2 was applied to the other surface of the nonmagnetic layer 2 formed in the above manner by an extrusion coating method by a nozzle such that the thickness after processing was 0.2 μm, stretched and then dried. Then, a calender obtained by combining a plastic roll and a metal roll was used to carry out processing at the number of nips of four times, a processing temperature of 100° C. and a line pressure of 3500 N/cm, to form a magnetic layer 3.

(Back-Coat Layer 5 Forming Step)

A coating paint for forming the aforementioned back-coat layer 5 was applied to the other surface of the base film 4 formed in the above manner by an extrusion coating method by a nozzle such that the thickness after dried was 0.7 μm and then dried. Then, a calender obtained by combining a plastic roll and a metal roll was used to carry out processing at the number of nips of four times, a processing temperature of 100° C. and a line pressure of 3500 N/cm, to form a back-coat layer 5.

The magnetic recording tape precursor was thermally cured at 60° C. for 48 hours and cut into a width of 1.2 inch (=12.650 mm) by slitting to manufacture a sample of a data magnetic tape as a magnetic recording medium of Example 1.

### EXAMPLES 2 to 4

Each sample of data magnetic tapes of Examples 2 to 4 were manufactured in the same manner as in Example 1 except that the aforementioned polyurethane resins (II), (III) and (IV) were used in place of the polyurethane resin (I) in the preparation of the coating paint for forming the nonmagnetic layer.

### COMPARATIVE EXAMPLE 1

A sample of a magnetic tape of Comparative Example 1 was manufactured in the same manner as in Example 1 except that the polyurethane resin (V) in which the amount of unsaturated hydrocarbons was less than 800 eq/t was used in place of the polyurethane resin (I) in the preparation of the coating paint for forming the nonmagnetic layer.

### COMPARATIVE EXAMPLE 2

A sample of a magnetic tape of Comparative Example 2 was manufactured in the same manner as in Example 1 except that the polyurethane resin (VI) using polyester polyol containing no aliphatic dicarboxylic acid as the acid component was used in place of the polyurethane resin (I) in the preparation of the coating paint for forming the nonmagnetic layer.

### COMPARATIVE EXAMPLE 3

A sample of a magnetic tape of Comparative Example 3 was manufactured in the same manner as in Example 1 except that the polyurethane resin (VII) in which the concentration of a metal phosphate group was less than 50 eq/t was used in place of the polyurethane resin (I) in the preparation of the coating paint for forming the nonmagnetic layer.

### COMPARATIVE EXAMPLE 4

A sample of a magnetic tape of Comparative Example 4 was manufactured in the same manner as in Example 1 except that the polyurethane resin (VIII) in which the concentration of a metal phosphate group exceeded 100 eq/t and the amount of unsaturated hydrocarbons exceeded 1600 eq/t was used in place of the polyurethane resin (I) in the preparation of the coating paint for forming the nonmagnetic layer.

(Evaluation of the Polyurethane Resin and Magnetic Recording Medium)

Each polyurethane resin and each sample of magnetic recording medium were evaluated in the following manner. The results are shown in Table 3.

(1) Evaluation 1: Evaluation of Crosslinking Ability

A solution containing each polyurethane resin in a solid content of 20% by weight (solvent: MEK) was prepared as a coating paint. This coating paint was applied to a peelable film by an applicator and dried at ambient temperature for 12 hours and at 90° C. for 15 minutes to manufacture a resin film 20 μm in thickness. This coated film was used as a sample for evaluating crosslinking ability. The obtained resin film which had been uncured by radiation was irradiated with electron beams at a dose of 2.0 Mrad to carry out an electron beam-radiation. Then, the cured resin film (hereinafter, electron beam-curable resin film) was peeled from the peelable film and cut into a size of about 1 cm×4 cm. The weight (defined as A (g)) of the cut electron beam-curable resin film was measured, and then, the cut electron beam-curable resin film was refluxed for 5 hours in MEK. The cut electron beam-curable resin film after refluxed was dried at 70° C. for 24 hours and then its weight (defined as B (g)) was measured. Using the obtained results, the crosslinking ability of the cut electron beam-curable resin film at the above dose was found according to the following equation.

Crosslinking ability (%)=(B/A) 100

(2) Evaluation 2: Center Line Average Roughness (Ra)

With regard to each sample of Examples and Comparative Examples, the center line average roughness Ra on the surface of the magnetic layer 3 was measured using “TALYSTEP System” (manufactured by Taylor Hobson K.K.) based on JIS B0601-1982. The measurement was made in the following condition: filter: 0.18 to 9 Hz, tracer: 0.1×2.5 μm stylus, tracer pressure: 2 mg, measuring speed: 0.03 mm/sec and measuring length: 500 μm. The center line average roughness Ra on the surface of the magnetic layer 3 was measured after final calendering treatment and curing treatment.

(3) Evaluation 3: Bit Error Rate

A single recording wavelength having a recording wavelength of 0.25 μm was recorded in each magnetic tape sample of the examples and comparative examples each incorporated into a cartridge by a magnetic record head to detect four or more continuous missing pulses as a Long Defect when a signal having a P—P value (amplitude) reduced to 50% or less of the P—P value (amplitude) of the input signal was defined as the missing pulse. The number of Long Defects per meter of the tape of Comparative Example 2 which was the standard tape was defined as N and the number of Long Defects per meter of each magnetic tape obtained in Examples 1 to 4 and Comparative Examples 1 to 4 was defined as X to calculate Log₁₀(X/N) of each of the examples and comparative examples as a bit error rate, thereby comparing each obtained bit error rate. In this case, a magnetic resistance effect type magnetic head (MR head) was used as the reproducing head.

TABLE 3

| | | Average major | | Center | |
|---|---|---|---|---|---|
| | | axis length of | Cross- | line | |
| | Poly- | nonmagnetic | linking | average | Bit |
| | urethane | particles | ability | roughness | error |
| | resin | (nm) | (%) | (nm) | rate |
| Example 1 | (I) | 100 | 90 | 4 | −1 |
| Example 2 | (II) | 100 | 95 | 3 | −1.5 |
| Example 3 | (III) | 100 | 95 | 4 | −1 |
| Example 4 | (IV) | 100 | 93 | 3 | −1.5 |
| Comparative | (V) | 100 | 75 | 4 | −1 |
| Example 1 | | | | | |
| Comparative | (VI) | 100 | 55 | 5 | ±0.00 |
| Example 2 | | | | | |
| Comparative | (VII) | 100 | 95 | 7 | +1 |
| Example 3 | | | | | |
| Comparative | (VIII) | 100 | 98 | 5 | ±0.00 |
| Example 4 | | | | | |

From the results of the measurement of the degree of crosslinking of each polyurethane resin shown in Table 3, it was confirmed that the polyurethane resins (I) to (IV) used in Examples 1 to 4 had sufficient crosslinking ability (80% or more) even though in Example 1 to 4 using the polyurethane resins (I) to (IV) electron beams at a dose as low as 2.0 Mrad are used. On the other hand, the polyurethane resins (V) to (VIII) used in Comparative Examples 1 to 4 each brought about only insufficient crosslinking ability (80% or more).

From the results of the measurement of the center line average roughness Ra shown in Table 3 and the results of the comparison between the bit error rates, it was confirmed that each sample of Examples 1 to 4 using the polyurethane resins (I) to (IV) could be sufficiently reduced in center line average roughness to a lower value (4 nm or less) and therefore, the magnetic layer 3 with a smooth surface could be formed. It was also confirmed that the samples can attain a sufficiently lower bit error rate as compared with Comparative Examples 2 to 4 deteriorated in center line average roughness Ra. On the other hand, it was confirmed that in the case of the samples of Comparative Examples 2 to 4 using the polyurethane resins (VI) to (VIII), the center line average roughness Ra could not be made to be sufficiently lower (4 nm or less).

As mentioned above, it is understood from the results of the evaluations 1 to 3 that a magnetic recording medium 1 can be manufactured which is provided with sufficient crosslinking ability, is sufficiently reduced in centerline average roughness Ra and has sufficiently lower bit error rate even though the medium is irradiated with electron beams at a dose as low as 2.0 Mrad. Also, since the magnetic recording medium 1 having a sufficiently bit error rate can be manufactured at a lower radiation dose, the productivity of the magnetic recording medium 1 can be improved. As a result, an inexpensive magnetic recording medium 1 can be attained.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A magnetic recording medium having a structure in which a magnetic layer containing magnetic particles and a binder is formed on a nonmagnetic layer containing nonmagnetic particles and a binder, wherein;
the binder contained in the nonmagnetic layer contains a polyurethane resin having 50 to 100 eq/t of a metal phosphate group and 800 to 1600 eq/t of unsaturated hydrocarbon groups in its molecule and is obtained by reacting a polyester polyol (A) containing an aliphatic dicarboxylic acid as the acid component, an aromatic polyisocyanate compound (B) and a compound (C) having unsaturated hydrocarbon groups and a functional group which reacts with an isocyanate group and a molecular weight of 500 or less.

2. The magnetic recording medium of claim 1, wherein the nonmagnetic particles contained in the nonmagnetic layer contain iron oxide particles having an average major axis length of 150 nm or less.

3. The magnetic recording medium of claim 1, wherein the binder contained in the nonmagnetic layer is a polyurethane resin obtained by further reacting with a compound (D) having a functional group which reacts with an isocyanate group and having a molecular weight of 800 or less.

4. The magnetic recording medium of claim 1, wherein the polyester polyol (A) contain 70 to 100 mol % of an aliphatic dicarboxylic acid in the acid component and the compound (C) have 2 to 4 unsaturated hydrocarbon groups in a molecule.

5. The magnetic recording medium of claim 1, wherein the thickness of the magnetic layer is 300 nm or less.
